(19) United States
(12) Patent Application Publication
(10) Pub. No.: US 2025/0297165 A1
(43) Pub. Date: Sep. 25, 2025

(54) PROCESS FOR THE PRODUCTION OF OLEFINS BY STEAM CRACKING OF FEEDSTOCKS FROM PLASTIC WASTE

(71) Applicant: TotalEnergies OneTech, Courbevoie (FR)

(72) Inventors: Thomas COUSTHAM, Ablon (FR); Héléne COULOMBEAU-LEROY, Montivillers (FR); Ahmed AL FARRA, Le Havre (FR); Didrik HAUDEBOURG, Le Havre (FR)

(73) Assignee: TotalEnergies OneTech, Courbevoie (FR)

(21) Appl. No.: 18/860,316

(22) PCT Filed: May 5, 2023
(86) PCT No.: PCT/EP2023/062069

§ 371 Date: Oct. 25, 2024

(30) Foreign Application Priority Data
May 5, 2022 (FR) FR2204269

(51) Int. Cl. C10G 1/10; C10G 65/12

(52) U.S. Cl. CPC C10G 1/10; C10G 65/12; C10G 2300/1003; C10G 2300/4006; C10G 2300/4012

(57) ABSTRACT

A method for producing olefins by steam cracking, in particular from feedstocks coming from plastics waste, in particular from a composition comprising a plastic liquefaction oil, the composition comprising paraffins, olefins, aromatics, and heteroatoms.

### TECHNICAL FIELD

The present invention relates to a method for producing olefins by steam cracking, in particular from feedstocks coming from plastic waste.

### CONTEXT OF THE INVENTION

Olefins, and in particular C2-C5 light olefins, such as ethylene, propylene, butadiene, isobutylene, n-butene and isoprene, are monomers that make it possible to produce an entire range of polymers by suitable treatments (chlorination, oxidation, polymerization, etc.). These olefins are usually obtained by steam cracking of hydrocarbons of fossil origin such as naphtha, petrol, or ethane. With fossil resources becoming rare and environmental constraints increasing, manufacturers are seeking other hydrocarbon feedstocks for producing olefins by steam cracking.

Moreover, the large quantities of plastic waste produced and the environmental problems that they give rise to have led manufacturers to seek methods for recycling this waste, in particular those making it possible to produce novel monomers and then polymers and thus to loop the life-cycle of the plastic material. This recycling method is a chemical method consisting in liquefying the plastic waste, in particular by thermal method (typically by pyrolysis or by hydrothermal liquefaction), and then reintroducing the effluent produced into a conventional refining circuit. This liquefaction however consumes a great deal of energy and is therefore envisaged only for treating contaminated plastic waste that cannot be treated in another way (by mechanical recycling or depolymerization for example).

The large quantity of impurities present in the liquefaction oils of plastic waste requires pre-treating them before injecting them into a conventional refining circuit. Thus the pyrolysis or hydrothermal liquefaction of plastic waste is typically followed by purification comprising hydrotreatment and elimination of the contaminants by means of various purification methods such as distillation.

There are thus numerous pre-treatment methods aimed at eliminating chlorinated compounds. However, other impurities present in the plastic liquefaction oil quite simply prevent direct use thereof in other methods such as steam cracking. This is because steam crackers are highly sensitive to the presence of olefins or of dienes in the feed and to the presence of silicon or organic compounds of silicon. Furthermore, oxygenated compounds present in the plastic liquefaction oil can be converted into peroxides and thus favor the formation of polymers and gums. In particular, the presence of olefins and oxygenated compounds can give rise to undesirable polymerization during storage, during transport from the production site to the subsequent treatment site and during subsequent purification and treatment operations. Since purification operations are often implemented at high temperatures, an increase in the level of undesirable polymerization may thus be observed.

The document WO 2021/115982 describes a method for recovering, by deparaffinizing, the aliphatic hydrocarbons of a hydrocarbon feedstock comprising aliphatic hydrocarbons and polar compounds containing a heteroatom. This feedstock includes the liquid products resulting from the pyrolysis of plastic waste. The method described consists in mixing the feedstock to be treated with the solvent, cooling the mixture in a temperature range from 5° C. to −30° C. to obtain wax crystals and separating them in order to produce aliphatic hydrocarbons comprising wax and a deparaffinized liquid comprising the solvent, the polar compounds and optionally aromatics. This document provides for a steam cracking of the aliphatic hydrocarbons comprising wax directly, without intermediate hydrotreatment. These aliphatic hydrocarbons are defined as non-olefinic (paraffinic) aliphatic compounds and olefinic aliphatic compounds. The specifications of current steam-cracking units do however require reduced olefin contents (typically less than 1 ppm) in order to limit the risks of coking, which are not achieved by the deparaffinizing treatment described here.

Moreover, the behavior of the liquefaction oils from the plastic waste is difficult to predict because of the complexity of these oils. For example, gas chromatography analysis of a pyrolysis oil from plastic waste makes it possible to identify only 25 to 45% by weight of the compounds containing oxygen and nitrogen. Furthermore, the composition of these oils is highly variable according to the nature of the plastic waste treated.

There is therefore a permanent need for developing methods for producing high-value chemical products from plastic waste, whatever the origin thereof, in particular using existing conventional refining units.

### SUMMARY OF THE INVENTION

The invention aims to provide a method for producing olefins by steam cracking from a composition comprising a plastic liquefaction oil, said composition comprising paraffins, olefins, aromatics and heteroatoms, the method comprising:
(a) a step of separating part of the paraffins and olefins contained in said composition comprising at least one step (i) of crystallizing said composition by a reduction of the temperature of 10° C. to 60° from an initial temperature at which said composition is entirely liquid and obtaining a mixture comprising a solid product rich in paraffins and depleted of olefins, aromatics and heteroatoms, and an effluent depleted of paraffins and rich in olefins, aromatics and heteroatoms, followed by at least one step (ii) of separating said solid product and said effluent,
(b) a step of hydrotreatment of the solid product from step (a) and obtaining a hydrotreated effluent having a reduced olefin content, and optionally a reduced heteroatom and aromatic content,
(c) a step of steam cracking of the hydrotreated effluent and obtaining an effluent containing olefins.

This particular concatenation of steps makes it possible to treat, in a steam cracker, an effluent resulting from a composition comprising a plastic liquefaction oil but having olefin, aromatic and heteroatom contents in accordance with those required at the input of a steam-cracker method, and this whatever the contaminant content of the composition.

The method according to the invention makes it possible in particular to produce olefins from compositions containing C5-C150 hydrocarbons, most often in C5-C100. In particular, the separation step (a) can be implemented to separate the paraffins from the olefins present in compositions containing hydrocarbons without limitation as to the number of carbon atoms constituting them.

The composition treated by the method according to the invention can comprise at least 2% by mass plastic liquefaction oil(s). The remainder can then be composed of no more than 98% by mass a diluent or solvent such as a hydrocarbon and/or one or more components such as: a biomass liquefaction oil such as Panicum virgatum, a tall oil, a used food oil, an animal fat, a vegetable oil such as a colza, canola, castor, palm or soya oil, an oil extracted from an alga, an oil extracted from a fermentation of oleaginous microorganisms such as oleaginous yeasts, an oil from liquefaction of a biomass such as a lignocellulosic biomass such as a wood, paper and/or cardboard liquefaction oil, an oil obtained by pyrolysis of ground used furniture, an oil from liquefaction of elastomers, for example latex, optionally vulcanized, or tires, as well as mixtures thereof.

In one embodiment, the composition can comprise at least 5% by mass, at least 10% by mass, at least 25% by mass, at least 50% by mass, at least 75% by mass, at least 90% by mass or 100% by mass plastic liquefaction oil(s). The proportion by weight of plastic liquefaction oil(s) in the composition can lie in any interval defined by two of the previously fixed limits.

The heteroatoms contained in the composition treated in the present invention can be oxygen, nitrogen, sulfur, silicon, a metal and/or a halogen, in particular chlorine.

The solid product resulting from step (a) can contain from 45% m/m to 90% m/m paraffins, preferably from 50% m/m to 90% m/m paraffins, from 10 to 50% m/m olefins, preferably from 10 to 40% m/m olefins, from 0 to 2% m/m aromatics, from 2 to 15% m/m naphthenes, and optionally no more than 2% m/m heteroatoms.

In particular, step (a) can make it possible to eliminate at least 80% m/m of the chlorine and/or at least 85% m/m of the nitrogen and/or at least 50% m/m of the sulfur and/or at least 60% m/m of the silicon with respect to the respective quantities of chlorine, nitrogen, sulfur and silicon initially present in the composition forming part of the method according to the invention.

The hydrotreated effluent produced at step (b) can contain from 0 to 2% m/m olefins, preferably from 0 to 1% m/m. The total heteroatom content can be from 0 to 1% m/m.

Thus, the effluent produced at step (b) can contain 70% m/m or more paraffins, preferably 80% m/m or more paraffins, more preferably 90% m/m or more paraffins, in particular 97% m/m or more paraffins, preferably 98% m/m or more paraffins.

The effluent from step (b) can advantageously contain C10+ paraffins, for example C10-C100 paraffins, most often in C10-C80.

Advantageously, the hydrotreated effluent produced at step (b) can furthermore contain:
no more than 100 ppm oxygen (measured in accordance with ASTM D5622/D2504),
no more than 20 ppm nitrogen (measured in accordance with ASTM D4629),
no more than 500 ppm sulfur (measured in accordance with ISO 20846),
no more than 120 ppm chlorine (measured in accordance with ASTM D7359-18),
optionally no more than 15 ppm silicon (measured by XRF).

In one embodiment, during the separation step (a), said composition can be mixed with at least one solvent prior to the at least one crystallization step (i). It will then advantageously be possible to provide a step (iii) of separating the at least one solvent from the effluent resulting from the separation step (ii) and the returning of the at least one solvent separated to step (i).

The solvent can advantageously be an organic solvent, for example selected from an aliphatic hydrocarbon, an aromatic hydrocarbon, a ketone, an alcohol or mixtures thereof, preferably a ketone or an alcohol. Examples of solvents that can be used comprise acetone, methyl ethyl ketone and isopropanol.

It will in particular be possible to select a solvent or a mixture of solvents that does not crystallize at the crystallization temperature of the paraffins to be separated, preferably a solvent or a mixture of solvents in the liquid state and miscible with the composition at the implementation temperatures of step (a) of the method of the present invention and in particular the at least one crystallization step (i). A person skilled in the art will be able to determine the most suitable solvent or mixture of solvents according to the temperatures used during step (a) by tests and/or simulations. In particular, when the feedstock to be treated is solid and/or highly viscous, it may be necessary to heat the feedstock to achieve the initial temperature before reducing the temperature by 10 to 60° C.: a solvent or mixture of solvents that remains liquid at these temperatures will then be selected.

The volume ratio of said composition to the solvent can be from 10/90 v/v to 90/10 v/v, or from 20/80 v/v to 80/20 v/v, preferably from 40/60 v/v to 60/40 v/v or from 45/55 v/v to 55/45 v/v, for example 50/50 v/v, or in any interval defined by two of these ratios.

The separation step (a) can be implemented in a single step or in two steps to improve the separation and recovery of the paraffins. The separation step (a) can then comprise:
(i-1) a first step of crystallization by reduction of the temperature of said composition of 10° C. to 60° C. from a first initial temperature at which said composition is entirely liquid and the obtaining of a first mixture comprising a first solid product rich in paraffins and depleted of olefins, aromatics and heteroatoms, and a first effluent depleted of paraffins and rich in olefins, aromatics and heteroatoms,
(ii-1) a first step of separating said first solid product and said first effluent,
(i-2) a second step of crystallization by reduction of the temperature of said first effluent of 10° C. to 60° C. from a second initial temperature at which said first effluent is entirely liquid and the obtaining of a second mixture comprising a second solid product rich in paraffins and depleted of olefins, aromatics and heteroatoms, and a second effluent depleted of paraffins and rich in olefins, aromatics and heteroatoms,
(ii-2) a second step of separating said second solid product and said second effluent, and
the first solid product and the second solid product are subjected to the hydrotreatment step (b).

When a solvent or a mixture of solvents is added to the composition, it is then added before the first crystallization step (i-1). Preferably, no solvent is added before the second crystallization step (i-2).

The crystallization step (i) or each of the crystallization steps (i-1) and (i-2) is implemented from an initial temperature at which the composition (alone or in a mixture with a solvent), or the first effluent, is entirely liquid, to a final temperature, 10 to 60° C. below the initial temperature.

The initial temperature of step (i) or of each of steps (i-1) and (i-2) can easily be determined by a person skilled in the art by normal measurement methods. The initial temperature is typically higher (for example by 5 to 10° C.) than the crystallization temperature of the paraffins to be separated from the composition. This crystallization temperature can be determined by differential calorimetry methods (P. Claudy et al, Diesel fuels: determination of onset crystallization temperature, pour point and filter plugging point by differential scanning calorimetry. Correlation with standard test methods. Fuel, 1986, vol 65, pp 861-4).

Step (a) can advantageously be implemented under conditions able to separate C10+ paraffins, for example C10-C100 paraffins, most often in C10-C80. These conditions comprise the final temperature of step (i) or of each of steps (i-1) and (i-2) mentioned above, typically below the melting point of the paraffins of interest, and optionally the cooling speed and/or the quantity of solvent used. The conditions for separating the paraffins of interest can easily be determined by a person skilled in the art by tests and/or simulations.

During the separation step (a), the separation step (ii), (ii-1) or (ii-2) can be implemented by at least one step selected from filtration, decantation or centrifugation. This separation step (ii), (ii-1) or (ii-2) is typically implemented at a temperature lower than or equal to the final temperature of step (i), (i-1) or (i-2) in order to recover the solid product.

In one embodiment, the solid product resulting from step (a), before being hydrotreated at step (v), can be washed, one or more times, typically three times, by at least one solvent, preferably at a temperature lower than or equal to the final temperature. This solvent is as defined previously. When at least one solvent is used during the crystallization step (i), (i-1) or (i-2), it will advantageously be possible to use the same solvent or mixture of solvents for this washing step. This washing step can advantageously be followed by a step of drying or evaporating the washed solid product, making it possible to eliminate the residual solvent or solvents before hydrotreatment (b).

During the hydrotreatment of step (b), 98% m/m or more of the olefins can be hydrogenated, in particular by selecting adapted operating conditions.

The effluent of step (b) can advantageously contain 70% m/m or more C10+ paraffins, for example C10-C100 paraffins, most often in C10-C80, preferably 80% m/m or more of these paraffins, more preferably 90% m/m or more of these paraffins, in particular 97% m/m or more of these paraffins, preferably 98% m/m or more of these paraffins.

The hydrotreatment of step (b) can be implemented in a single step or in two steps. When it is implemented in a single step, the solid product or products resulting from step (a) are hydrogenated at a temperature of 200 to 450° C., preferably from 200 to 340° C. in the presence of hydrogen at an absolute pressure of 20 to 140 bar, preferably from 30 to 100 bar and in the presence of a hydrotreatment catalyst, for example a hydrogenation catalyst comprising NiMo (0.1-60% by mass) and/or CoMo (0.1-60% by mass).

Alternatively, the hydrotreatment of step (b) can be implemented in a first step (b-1) wherein the solid product or products resulting from step (a) are hydrogenated at a temperature of 80 to 250° C., preferably 130 to 190° C. in the presence of hydrogen at an absolute pressure of between 5 and 60 bar, preferably 20 to 30 bar, and in the presence of a first hydrotreatment catalyst, for example a hydrogenation catalyst comprising Pd (0.1-10% by weight) and/or Ni (0.1-60% by weight) and/or NiMo (0.1-60% by weight), and in a second step (b-2) wherein the effluent resulting from step (b-1) is hydrogenated at a temperature of 200 to 450° C., preferably from 200 to 340° C., in the presence of hydrogen at an absolute pressure of 20 to 140 bar, preferably from 30 to 100 bar, and in the presence of a second hydrotreatment catalyst, for example a hydrogenation catalyst comprising NiMo (0.1-60% by weight) and/or CoMo (0.1-60% by weight). The first step can then make it possible to hydrogenate dienes initially present in the composition and which were crystallized with the paraffins in the solid product or products.

Prior to the steam-cracking step (c), the hydrotreated effluent resulting from step (b) can be subjected to a cracking reaction in order to reduce the length of the carbon chains of the paraffins present in the hydrotreated effluent.

Typically, this cracking reaction is a hydrocracking reaction implemented at a temperature of 250 to 480° C., a partial hydrogen pressure of 1.5 to 25 MPa abs. and an hourly volume velocity of 0.1 to 10 h⁻¹.

The steam-cracking step (e) consist in thermally cracking, in one or more reactors, a mixture of the hydrotreated effluent and steam at high temperatures of the order of 650 to 1000° C., preferably from 700 to 900° C., typically from 750 to 850° C., at low pressures (1 to 3 bar). The cracking reaction is implemented in the absence of oxygen. The reaction time is normally very short, of the order of milliseconds. These conditions make it possible to break the carbon-carbon bonds and to produce unsaturated hydrocarbons with smaller molecules than the feedstock introduced into the reactor or reactors. The effluent leaving the reactor or reactors are next rapidly cooled to temperatures of 400 to 550° C. in order to limit the secondary reactions of the olefin, diene and acetylene polymerization type. The cooled effluents are finally fractionated to recover the C2-C5 light olefins, such as ethylene, propylene, butadiene, isobutylene, n-butene and isoprene.

Another object of the invention is a method for upgrading plastic waste comprising the following steps:
(A) a step of liquefying waste containing plastics materials and obtaining a hydrocarbon product comprising a gaseous phase, a liquid phase and a solid phase,
(B) a step of separating the liquid phase from said product, said liquid phase forming a plastic liquefaction oil,
(C) a step of treating at least part of the liquid phase by an olefin-production method according to the invention.

The liquefaction step (A) can comprise a pyrolysis step typically implemented at a temperature of 300 to 1000° C. or of 400 to 700° C., this pyrolysis being for example a rapid pyrolysis or a flash pyrolysis or a catalytic pyrolysis or a hydropyrolysis.

Alternatively or in combination, the liquefaction step (A) can comprise a hydrothermal liquefaction step, typically implemented at a temperature of 250 to 500° C. and at pressures of 10 to 25-40 Mpa.

The waste treated at step (A) can be plastic waste optionally mixed with biomass, as previously described.

The separation step (B) makes it possible to eliminate the gaseous phase, essentially C₁-C₄ hydrocarbons, and the solid phase (typically char) so as to recover only the liquid organic phase forming a liquefaction oil.

This plastic liquefaction oil typically comprises 30 to 55% by mass paraffins, 10 to 50% m/m olefins, and 5 to 12% m/m aromatics. These proportions can be determined by gas chromatography.

In particular, a plastic liquefaction oil can comprise a bromine index of 20 to 60 g Br/100 g and/or a maleic anhydride index (UOP326-82) of 1 to 20 mg of maleic anhydride/1 g.

A plastic liquefaction oil can in particular comprise one or more of the following heteroatom contents: from 0 to 8% m/m oxygen measured in accordance with ASTM D5622), from 1 to 13,000 ppm of nitrogen (measured in accordance with ASTM D4629), from 2 to 10,000 ppm of sulfur (measured in accordance with ISO 20846) from 1 to 10,000 ppm of metals (measured by ICP), from 50 to 6000 ppm of chlorine (measured in accordance with ASTM D7359-18), from 0 to 200 ppm of bromine (measured in accordance with ASTM D7359-18), from 1 to 40 ppm of fluorine (measured in accordance with ASTM D7359-18), 1 to 2000 ppm of silicon (measured by XRF).

A plastic liquefaction oil can in particular comprise one or more of the following heteroatom contents: from 0 to 8% m/m oxygen, from 250 to 3,800 ppm of nitrogen, from 35 to 850 ppm of sulfur, from 34 to 900 ppm of metals, from 50 to 6000 ppm of chlorine, from 0 to 10 ppm of, from 1.5 to 10 ppm of fluorine.

This liquid phase can next be subjected, in part (in particular a fraction thereof) or in whole, to the method for producing olefins of the invention, alone or in a mixture with other components as previously described for producing the olefins of interest by steam cracking.

A fraction of this liquid phase, corresponding for example to a naphtha or diesel cut, can in particular be subjected to the olefin-production method according to the invention, alone or in a mixture with other components as previously described.

Advantageously, the composition treated in the present invention can have at least 50% m/m paraffins and olefins, in particular C5-C150 paraffins and olefins, most often in C5-C100, preferably at least 55% m/m, 60% m/m or 65% m/m paraffins and olefins, and/or no more than 95% m/m, 90% m/m, 85% m/m or 80% m/m paraffins and olefins. The paraffins and olefins content, in particular C5-C150, most often in C5-C100, paraffins and olefins, of the treated composition can lie in any range defined by two of these limits.

### Definitions

The terms “comprising” and “comprises” as used here are synonymous with “including”, “includes” or “contains”, “containing”, and are inclusive or without limits and do not exclude additional features, elements or steps of methods not specified.

The expressions % by weight and % by mass have an equivalent meaning and refer to the proportion of the mass of a product relative to 100 g of a composition comprising it.

The expression “plastic liquefaction oil” or “oil resulting from plastic liquefaction” or “plastic-waste liquefaction oil” or “liquefaction oil resulting from the liquefaction of waste containing plastics materials” refers to the liquid products obtained at the end of a pyrolysis or of a hydrothermal liquefaction of thermoplastic, thermosetting or elastomer polymers, alone or in a mixture and generally in the form of waste, optionally in a mixture with at least one other waste such as biomass, for example selected from lignocellulosic biomass, paper and cardboard.

The pyrolysis method must be understood as a thermal cracking method, implemented in the presence or not of catalyst (for example rapid pyrolysis, catalytic or not, etc.). The hydrothermal liquefaction (or HTL) method is a thermochemical conversion method using water as a solvent, reagent and catalyst for the degradation reactions of plastics materials or of biomass, the water typically being in a subcritical or supercritical state.

The plastics material may be of any type, in particular any type of new or used plastics material, included in domestic (post-consumption) or industrial waste. Plastics materials means the materials consisting of polymers and optionally auxiliary components such as plasticizers, fillers, dyes, catalysts, fire retardants, stabilizers, etc. For example, these polymers may be polyethylene, halogenated (Cl, F) or not, polypropylene, polystyrene, polybutadiene, polyisoprene, polyethylene terephthalate (PET), acrylonitrile-butadiene-styrene (ABS), polybutylene, polybutylene terephthalate (PBT), polyvinyl chloride (PVC), polyvinylidene chloride, a polyester, a polyamide, a polycarbonate, a polyether, a polymer epoxide, a polyacetal, a polyimide, a polyester amide, silicone, etc. In general, it will be possible to use any polymer or mixture of polymers able to produce paraffins by liquefaction.

These plastic liquefaction oils contain paraffins, i-paraffins (isoparaffins), dienes, alkynes, olefins, naphthenes and aromatics. Plastic liquefaction oils also contain impurities containing heteroatoms, such as chlorinated, oxygenated and/or silylated organic compounds, metals, salts, phosphorus compounds, sulfur and nitrogen.

The composition of the plastic liquid oil is dependent on the nature of the liquefied plastic and mainly (in particular to more than 80% m/m, usually to more than 90% m/m) consists of hydrocarbons having from 1 to 150 carbon atoms and impurities. Biomass can be defined as a vegetable or animal organic product. Biomass thus comprises (i) the biomass produced by the surplus of agricultural land not used for human or animal food: dedicated cultivations, referred to as energy cultivations; (ii) the biomass produced by clearance (forest maintenance) or cleaning of agricultural lands; (iii) the agricultural residues resulting from cultivations of cereals, vines, orchards, olive trees, fruits and vegetables, food residues, etc.; (iv) forest residues resulting from forestry and timber conversion; (v) agricultural residues resulting from animal husbandry (dung, manure, litter, droppings, etc.); (vi) domestic organic waste (paper, cardboard, green waste, etc.); (vii) ordinary industrial organic waste (paper, cardboard, wood, putrescible waste, etc.). The liquefaction oil treated by the invention can come from the liquefaction of waste containing at least 1% m/m, optionally from 1 to 50% m/m, from 2 to 30% m/m or in an interval defined by any two of these limits, of one or more of the aforementioned biomasses, residues and organic waste, and the rest consisting of plastic waste.

The expression “MAV” (the acronym of “Maleic Anhydride Value”) refers to the UOP326-82 method that is expressed in mg of maleic anhydride that reacts with 1 g of sample to be measured.

The expression “bromine index” is the number of milligrams of bromine that react with 100 g of sample and can be measured in accordance with the ASTM D1159-07 (2017) method.

The concentration of metals in the hydrocarbon matrices can be determined by any known method. Acceptable methods include X-ray fluorescence (XRF) and inductive coupling plasma atomic emission spectrometry (ICP-AES). Specialists in analytical sciences are able to identify the method most adapted to measuring each metal and each heteroelement according to the hydrocarbon matrix in question.

The paraffin, olefin, naphthalene and aromatic hydrocarbon content can be determined by multidimensional gas chromatography, example in accordance with the method described in the document Duhamel, Journal of Chromatography A, 1387 (2015) 95-103, Comparison of cryogenic and differential flow modulator.

The oxygen content can be measured in accordance with the standard: ASTM D5622-17/D2504-88 (2015). The nitrogen content can be measured in accordance with the standard: ASTM D4629-17. The sulfur content can be measured in accordance with ISO 20846:2011. The halogen content, in particular chlorine, bromine, chlorine, can be measured in accordance with the standard: ASTM D7359-18. The silicon content can be measured by XRF.

The particular features, structures, properties and embodiments of the invention can be combined freely in one or more embodiments not specifically described here, as will be apparent to specialists in treating plastic liquefaction oils using their general knowledge.

“Hydrotreatment catalyst” means a catalyst favoring the incorporation of hydrogen in the products. This type of catalyst is typically a metal catalyst comprising one or more metals in groups 3, 4, 5, 6, 7, 8, 9, 10, 11, 12, 13 and 14 of the periodic table.

### DESCRIPTION OF THE INVENTION

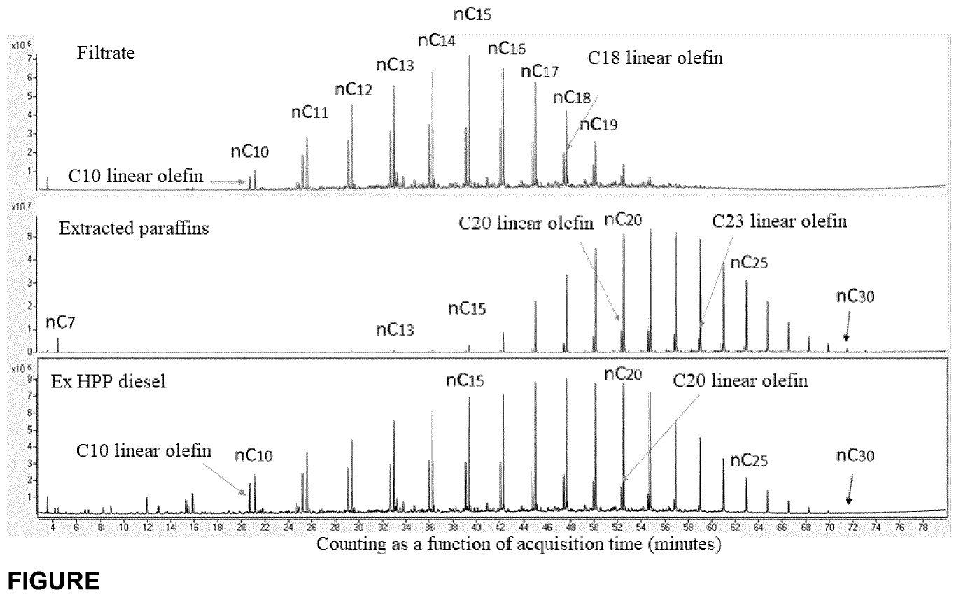

FIG. 1 shows the GC-MS spectra of the products of example 4.

### EXAMPLES

The embodiments of the present invention are illustrated by the following non-limitative examples.

### Example 1: Separation of the Paraffins by Crystallization in Acetone or in an Acetone-Isopropanol Mixture

A plastic pyrolysis oil HPP1 was mixed at ambient temperature (i.e. approximately 10° C. above the crystallization temperature of the paraffins to be separated) (T°=25° C., P=1 atm) with a crystallization solvent (acetone or 50/50 (v/v) mixture of acetone and isopropanol) to lead to a clear homogeneous solution. Then the temperature of the mixture was reduced from this initial temperature of 25° C. to a final temperature of −20° C. (i.e. a temperature delta of 45° C.). The formation of a solid product (called cake) is observed. The cake was separated by filtration, washed with the crystallization solvent and then dried and analyzed.

Table 1 sets out the compositions of the pyrolysis oil and of the cakes resulting from the two filtrations. It is noted that the solid product recovered contains mainly paraffins, with an appreciable quantity of olefins and a very small quantity of aromatics. Furthermore, it was possible to determine a reduction of more than 80% m/m in the Cl, more than 85% m/m in the nitrogen, more than 50% m/m in the sulfur and more than 60% m/m in the Si initially present in the HPP1.

TABLE 1

| | HPP1 | Cake 1 | Cake 2 |
|---|---|---|---|
| Solvent | — | Acetone | Acetone/iso- |
| | | | Propanol |
| | | | (50/50) |
| Ratio (solvent/feedstock) | — | 50/50 | 50/50 |
| (v/v) | | | |
| Ramp | — | Quenching | Quenching |
| Final temperature | — | −20° C. | −20° C. |
| Yield (% m) | | 11.5 | 7.6 |

| FAMILY | % m/m | % m/m | % m/m |
|---|---|---|---|
| Paraffins | 35.8 | 60.1 | 63.8 |
| Olefins (*) | 42.6 | 36.1 | 35.2 |
| Mononaphthenes | 6.0 | 2.8 | 0.6 |
| Polynaphthenes | 5.7 | 0.7 | 0.2 |
| Monoaromatics | 6.8 | 0.4 | 0.2 |
| Diaromatics | 0.4 | 0.0 | 0.0 |
| Triaromatics | 0.0 | 0.0 | 0.0 |
| Tetra-aromatics + | 0.0 | 0.0 | 0.0 |
| Unidentified unknowns | 0.6 | 0.0 | 0.0 |
| Other molecules | 2.0 | 0.0 | 0.0 |
| TOTAL | 100 | 100 | 100 |

(*) includes linear and branched olefins, linear and branched diolefins, saturated naphthenes.

### Example 2: Separation of the Paraffins by Crystallization in Acetone or in an Acetone-Isopropanol Mixture

A plastic pyrolysis oil HPP1′ was subjected to the same treatment as that described in example 1 and a cake (denoted cake 1′) was recovered.

Tables 2 and 3 give respectively the compositions of the oil HPP1′ and of the cake 1′. The oil HPP1′ and the cake 1′ were analyzed by GCxGC-FID by means of a GCxGC bidimensional chromatograph equipped with an apolar capillary column in first dimension (1D) and a capillary column of intermediate polarity in second dimension (2D). The detection is made by a flame ionization detector (FID).

A first separation on the 1D column separates the compounds according to their boiling points. They are trapped periodically in the modulation loop and injected into a second column that separates the compounds according to their polarities. The chromatogram obtained is demodulated in the form of a bidimensional retention plan and exploited via dedicated software (for example GC Image). The quantification of the compounds is done by normalization to 100% of the compounds detected by FID.

In tables 2 and 3, the n-olefin contents include the n-olefin and n-diolefin contents.

TABLE 2

| | HPP1′ | Cake 1′ |
|---|---|---|
| FAMILY | % m/m | % m/m |
| saturates <C9 (excluding n- | 16.03 | |
| paraffins and n-olefins) | | |
| n-paraffins | 18.69 | 52.50 |
| Iso-paraffins | 13.04 | 6.96 |
| n-olefins | 34.77 | 35.07 |
| Mononaphthenes | 5.73 | 2.46 |
| Polynaphthenes | 3.97 | 0.69 |
| Monoaromatics | 6.94 | 0.33 |
| Diaromatics | 0.32 | 0.00 |
| Triaromatics | 0.02 | 0.00 |
| Tetra-aromatics + | 0.00 | 0.00 |
| Unidentified unknowns | 0.50 | 1.99 |
| Other molecules | 0.00 | 0.00 |
| TOTAL | 100.00 | 100.00 |

TABLE 3

| HPP1′ | | | | Cake 1′ | | | |
|---|---|---|---|---|---|---|---|
| n-paraffins | % m/m | n-olefins | % m/m | n-paraffins | % m/m | n-olefins | % m/m |
| nC7 | 1.25 | C7 | 1.47 | nC7 | 0.00 | | |
| nC8 | 0.94 | C8 | 1.50 | nC8 | 0.00 | <C9 | 0.01 |
| nC9 | 0.87 | C9 | 2.48 | nC9 | 0.00 | C9 | 0.01 |
| nC10 | 0.99 | C10 | 2.64 | nC10 | 0.00 | C10 | 0.00 |
| nC11 | 1.17 | C11 | 3.60 | nC11 | 0.02 | C11 | 0.01 |
| nC12 | 0.95 | C12 | 2.36 | nC12 | 0.06 | C12 | 0.03 |
| nC13 | 1.02 | C13 | 2.08 | nC13 | 0.17 | C13 | 0.06 |
| nC14 | 1.04 | C14 | 2.47 | nC14 | 0.39 | C14 | 0.16 |
| nC15 | 1.16 | C15 | 1.96 | nC15 | 1.02 | C15 | 0.32 |
| nC16 | 1.35 | C16 | 1.92 | nC16 | 2.13 | C16 | 0.67 |
| nC17 | 1.20 | C17 | 2.25 | nC17 | 4.03 | C17 | 1.39 |
| nC18 | 1.13 | C18 | 2.21 | nC18 | 5.94 | C18 | 2.90 |
| nC19 | 1.13 | C19 | 1.99 | nC19 | 7.67 | C19 | 4.26 |
| nC20 | 1.38 | C20 | 1.76 | nC20 | 8.88 | C20 | 5.86 |
| nC21 | 1.07 | C21 | 1.49 | nC21 | 8.17 | C21 | 7.08 |
| nC22 | 1.04 | C22 | 1.37 | nC22 | 7.51 | C22 | 5.92 |
| nC23 | 0.57 | C23 | 0.77 | nC23 | 3.90 | C23 | 4.02 |
| nC24 | 0.29 | C24 | 0.31 | nC24 | 1.73 | C24 | 1.54 |
| nC25 | 0.09 | C25 | 0.08 | nC25 | 0.56 | C25 | 0.53 |
| nC26 | 0.03 | C26 | 0.04 | nC26 | 0.20 | C26 | 0.20 |
| nC27 | 0.01 | C27 | 0.01 | nC27 | 0.05 | C27 | 0.08 |
| nC28 | 0.00 | C28 | 0.00 | nC28 | 0.03 | C28 | 0.02 |
| nC29 | 0.00 | C29 | 0.00 | nC29 | 0.03 | C29 | 0.00 |
| nC30 | 0.00 | C30 | 0.00 | nC30 | 0.01 | C30 | 0.00 |
| nC31 | 0.00 | C30+ | 0.00 | nC31 | 0.00 | C30+ | 0.00 |
| TOTAL | 18.69 | TOTAL | 34.77 | TOTAL | 52.50 | TOTAL | 35.07 |

### Example 3: Separation of the Paraffins by Crystallization in Acetone or in an Acetone-Isopropanol Mixture

Four tests were implemented on another plastic pyrolysis oil HPP2 using acetone and an 80/20 v/v acetone/isopropanol mixture as crystallization solvents.

The plastic pyrolysis oil HPP2 was mixed at ambient temperature (T°=25° C., P=1 atm) with the crystallization solvent (acetone or 80/20 (v/v) mixture of acetone and isopropanol) and then the temperature of the mixture was reduced from this initial temperature of 25° C. to a final temperature of 5° C. and 0° C. for tests 1 and 2 and of −10° C. for tests 3 and 4. The formation of a solid product (called cake) is observed. The cake was separated by filtration, washed with the crystallization solvent and then dried and analyzed. The conditions of the tests are set out in table 4. The analyses of the solids recovered (cakes) for tests 1 to 4 and the analyses of the plastics pyrolysis oil are set out in table 5.

TABLE 4

| | Test 1 | Test 2 | Test 3 | Test 4 |
|---|---|---|---|---|
| Feedstock/Solvent | 50/50 | 50/50 | 50/50 | 50/50 |
| | v/v | v/v | v/v | v/v |
| Solvent | Acetone | Acetone | Acetone | Acetone/iso- |
| | | | | propanol |
| | | | | (80/20) |
| Temperature ramp | −50° | −50° | −50° | −50° |
| | C./h | C./h | C./h | C./h |
| Final temperature | 5° C. | 0° C. | −10° C. | −10° C. |
| Yield (% m) | 4.5 | 8.2 | 18.8 | 14.7 |

TABLE 5

| | HPP2 | Cake test 3 | Cake test 4 |
|---|---|---|---|
| Cl (ppm) | 55 | 8 | 7 |
| N (ppm) | 157 | 13 | 10.5 |
| S (ppm) | 13.5 | 4.4 | 3.7 |
| Si (ppm) | 27 | 9 | 7 |
| Aromatics (% m/m | 3.70 | 0.06 | 0.05 |
| Naphthenes (% m/m) | 6.74 | 2.04 | 1.78 |

Tables 6 and 7 give respectively the compositions of the oil HPP2 and of the cake of test 3. In these tables, the n-olefin contents include the n-olefin and n-diolefin contents.

The oil HPP2 and the cake of test 3 were analyzed by GCxGC-FID in accordance with the same procedure as that described for the analyses of example 2.

TABLE 6

| | HPP2 | Cake test 3 |
|---|---|---|
| FAMILY | % m/m | % m/m |
| n-paraffins | 12.82 | 25.33 |
| Iso-paraffins | 39.94 | 22.89 |
| n-olefins | 36.63 | 49.78 |
| Mononaphthenes | 3.33 | 1.71 |
| Polynaphthenes | 3.42 | 0.29 |
| Monoaromatics | 2.95 | 0.00 |
| Diaromatics | 0.55 | 0.00 |
| Triaromatics | 0.22 | 0.00 |
| Tetra-aromatics + | 0.00 | 0.00 |
| Unidentified unknowns | 0.06 | 0.00 |
| Other molecules | 0.09 | 0.00 |
| TOTAL | 100.00 | 100.00 |

TABLE 7

| HPP2 | | | | Cake test 3 | | | |
|---|---|---|---|---|---|---|---|
| n-paraffins | % m/m | n-olefins | % m/m | n-paraffins | % m/m | n-olefins | % m/m |
| nC7 | 0.02 | | | nC7 | 0.00 | | |
| nC8 | 0.04 | <C9 | 0.20 | nC8 | 0.00 | <C9 | 0.00 |
| nC9 | 0.04 | C9 | 1.05 | nC9 | 0.00 | C9 | 0.00 |
| nC10 | 0.14 | C10 | 0.41 | nC10 | 0.00 | C10 | 0.00 |
| nC11 | 0.20 | C11 | 1.58 | nC11 | 0.00 | C11 | 0.09 |
| nC12 | 0.33 | C12 | 1.43 | nC12 | 0.11 | C12 | 0.17 |
| nC13 | 0.44 | C13 | 1.67 | nC13 | 0.15 | C13 | 0.39 |
| nC14 | 0.59 | C14 | 3.17 | nC14 | 0.34 | C14 | 0.99 |
| nC15 | 0.98 | C15 | 2.89 | nC15 | 0.63 | C15 | 1.25 |
| nC16 | 0.89 | C16 | 3.59 | nC16 | 1.16 | C16 | 1.28 |
| nC17 | 1.01 | C17 | 2.59 | nC17 | 1.22 | C17 | 1.54 |
| nC18 | 0.84 | C18 | 2.69 | nC18 | 1.66 | C18 | 2.11 |
| nC19 | 0.85 | C19 | 2.44 | nC19 | 2.09 | C19 | 3.00 |
| nC20 | 1.11 | C20 | 2.26 | nC20 | 2.83 | C20 | 4.01 |
| nC21 | 0.79 | C21 | 1.98 | nC21 | 2.28 | C21 | 4.96 |
| nC22 | 0.91 | C22 | 1.75 | nC22 | 2.43 | C22 | 5.35 |
| nC23 | 0.74 | C23 | 1.70 | nC23 | 2.20 | C23 | 5.45 |
| nC24 | 0.72 | C24 | 1.19 | nC24 | 2.16 | C24 | 4.64 |
| nC25 | 0.46 | C25 | 1.07 | nC25 | 1.01 | C25 | 4.38 |
| nC26 | 0.39 | C26 | 0.82 | nC26 | 1.54 | C26 | 2.89 |
| nC27 | 0.38 | C27 | 0.83 | nC27 | 1.10 | C27 | 2.63 |
| nC28 | 0.30 | C28 | 0.46 | nC28 | 0.84 | C28 | 1.72 |
| nC29 | 0.45 | C29 | 0.34 | nC29 | 0.89 | C29 | 1.16 |
| nC30 | 0.12 | C30 | 0.20 | nC30 | 0.42 | C30 | 0.70 |
| nC31 | 0.07 | C30+ | 0.31 | nC31 | 0.27 | C30+ | 1.08 |
| TOTAL | 12.82 | TOTAL | 36.63 | TOTAL | 25.33 | TOTAL | 49.78 |

### Example 4: Separation of the Paraffins by Crystallization in Acetone

A diesel cut of a plastic pyrolysis oil was deparaffinated by crystallization. This diesel cut, denoted “ex HPP diesel”, consists of C10-C30 hydrocarbons and contains 49.55% m/m paraffins and 41.30% m/m olefins.

The diesel cut was mixed at ambient temperature (i.e. approximately 10° C. above the crystallization temperature of the paraffins to be separated) (T°=25° C., P=1 atm) with acetone (volume ratio of ex HPP diesel to acetone of 50:50) to lead to a clear homogeneous solution. Then the temperature of the mixture was reduced from this initial temperature of 25° C. to a final temperature of −20° C. The formation of a solid product (called cake) is observed. The cake containing the crystallized paraffins was separated by filtration, washed with acetone and then dried and analyzed. The paraffins contained in the cake were extracted by dissolution in n-heptane heated to 90° C. and then evaporation of the n-heptane under nitrogen flow.

The deparaffinated oil (called filtrate) separated from the cake is recovered. The acetone contained in the filtrate was evaporated by means of a rotary evaporator at 70° C. under vacuum at a rotation speed of 60 rev/min, and then the vacuum is cut to send a flow of nitrogen into the flask for the purpose of having total evaporation of the acetone.

The compositions of the extracted paraffins and of the filtrate were analyzed as described with reference to example 2. The results are set out in table 8. The heteroatom contents of the ex HPP diesel, of the extracted paraffins and of the filtrate are set out in table 9.

TABLE 8

| | | Paraffins |
|---|---|---|
| | Filtrate | extracted |
| FAMILY | % m/m | % m/m |
| n-paraffins + iso-paraffins | 42.22 | 84.01 |
| olefins | 27.89 | 13.56 |
| Mononaphthenes | 10.90 | 2.22 |
| Polynaphthenes | 5.54 | 0.11 |
| Monoaromatics | 11.27 | 0.10 |
| Diaromatics | 1.51 | 0.00 |
| Triaromatics | 0.13 | 0.00 |
| Tetra-aromatics + | 0.03 | 0.00 |
| Unidentified compounds (unknown) | 0.52 | 0.00 |
| TOTAL | 100.00 | 100.00 |

TABLE 9

| | Ex HPP | | Paraffins |
|---|---|---|---|
| | diesel | filtrate | extracted |
| N (ppm) | 974 | 988 | 8.6 |
| S (ppm) | 50 | 41.5 | <3 |
| Si (ppm) | 12.9 | 30 | <3 |
| Cl (ppm) | 45 | 29.8 | <3 |

The ex HPP diesel cut, the extracted paraffins and the deparaffinated oil were analyzed by GC-MS under the following conditions:

### Preparation of the Samples:

All the samples were diluted in CS2 and analyzed by GCMS under the same conditions.
Approximately 0.1 g of product in 6 g of CS2

### Analytical Conditions:

Injection onto a GC-MS (GC-QTOF from Agilent) under the same conditions (slow programming to spread the molecules detected):
Split mode injector: 250° C.—ratio split 100—injected volume 1 μL
Column flow rate (He): 1 mL/min
Oven: 35° C. for 10 min, then 4° C./min up to 325° C. for 10 min
Apolar column: brand Thermo TG-5HT 30 m*0.25 mm*0.25 μm
Source temperature: 200° C.
Quad temperature: 150° C.
Electronic impact source at 70 eV.

The GC-MS analysis spectra obtained are set out in FIG. 1. On the spectrum of the ex HPP diesel, if the nC₁₅ are taken for example, the peak with great intensity is paraffin, and the adjoining peak with less intensity is the corresponding linear olefin. In this example, the ex Hpp diesel cut contains linear paraffins and linear olefins in C10-C30. The paraffins extracted are mainly nC15-nC30, with a small proportion of linear olefins. On the other hand, the filtrate contains mainly lighter C10-C19 fractions, with a greater proportion of olefins compared with the extracted paraffins.

### Example 5: Hydrotreatment and Steam Cracking of the Solid Product of Examples 1, 2, 3 or 4

One of the solids coming from the tests of examples 1 to 4 can be hydrotreated in accordance with the following procedure:

The solid can be introduced into an optional first hydrotreatment section (HDT1), mainly to hydrogenate the diolefins, and which is implemented in liquid phase. This step can comprise a plurality of reactors in series and/or parallel if guard reactors are used upstream or downstream of the first hydrogenation reactor. These guard reactors can make it possible to reduce the concentration of certain undesirable chemical species and/or elements such as chlorine, silicon and metals. Particularly undesirable metals include Si, Na, Ca, Mg, Fe and Hg.

A second hydrotreatment section (HDT2) is dedicated to the hydrogenation of the olefins and to demetallization (HDM), desulphurization (HDS), denitrogenation (HDN) and deoxygenation (HDO). HDT2 is implemented in gaseous phase. This section consists of one or more reactors operated in series, in lead-lag or in parallel.

As the hydrotreatment reactions in the HDT1 and HDT2 sections are exothermic, quenching by cold hydrogen can be used to moderate the increase in temperature and to control the reaction.

Isolated guard reactors, in lead-lag, in series and/or in parallel, can be envisaged depending on the nature and the quantity of the contaminant in the flow to be treated.

Should the treatments of examples 1, 2, 3 or 4 not make it possible to obtain sufficient reduction of impurities, guard reactors for eliminating chlorine and silicon can be operated in gaseous phase. Silicon can also be trapped on the top bed of a reactor of the HDT2 section or separately, upstream or downstream, by treatment of the hot gases leaving the HDT2 section.

Chlorine and mercury can be separated by guard reactors in liquid or gaseous phase.

There may be intermediate quenchings between the beds or between the HDT1 and HDT2 reactors or no quenching. In the latter case, recycling of part of the flow leaving the HDT1 or HDT2 must be implemented to control the temperature. A strict control of the temperature in HDT1 must be conducted when this step is implemented, in order to avoid blocking of the reactor and degradation of the catalytic hydrogenation conditions.

The operating pressure in each of the HDT1 and HDT2 hydrotreatments is 5-140 bar, preferably 20-30 bar, for HDT1, and 20-140 bar, preferably 30-100 bar, for HDT2, typically 30-40 bar for HDT2.

Typical temperature range at the input of HDT1 at the start of the cycle (SOR: start of run): 150-200° C. The catalyst for HDT1 normally comprises Pd (0.1-10% weight) and/or Ni (0.1-60% weight) and/or NiMo (0.1-60% weight).

Typical temperature range at the input of HDT2 at the start of the cycle (SOR: start of run): 200-340° C. Typical temperature range at the output of HDT2 (SOR): 300-380° C., up to 450° C. The catalyst for HDT2 normally comprises an NiMo (any type of commercial catalyst for refining or petrochemical application), potentially a CoMo in the very last beds at the reactor bottom (any type of commercial catalyst for refining or petrochemical application).

The top bed of the HDT2 should preferably be operated with an NiMo having a hydrogenating capability as well as a capability of trapping silicon. A top bed of this type can be considered to be an adsorbent as well as a metal trap also having an HDN activity and a hydrogenating capability. An example of a top bed acceptable for this function comprises the commercially available NiMo catalyzing adsorbents such as ACT971 and ACT981 from Axens or equivalents from Haldor Topsoe, Axens, Criterion, etc. It is possible to have two separate beds in an HDT2 reactor, with a quenching between the two beds or between the two reactors, if the two beds are in two distinct reactors, or no quenching at all. Ideally, the intermediate quenching is implemented by means of cold effluent from HDT2 or by an addition of cold hydrogen, i.e. at a temperature generally ranging from 15 to 30° C., in order to control the exotherm of HDT2. A dilution by recycling of the hydrocarbon flow to the top bed of HDT2 is not recommended because of the increased risks of fouling of the bed. The feedstock arriving on the HDT2 catalyst must be completely vaporized at any time, including in variable mode, as is the case during start-ups. Sending liquid hydrocarbons onto the top bed of an HDT2 reactor may cause fouling and an increase in the difference in pressure between the inlet and outlet of said HDT2 reactor and lead to premature stoppage.

Depending on any metals present in the solid to be hydrotreated, a hydrodemetallization catalyst, for example commercial, can be added to the top bed of the HDT2 section in order to protect the lower catalytic beds from deactivation.

The hydrotreated effluent leaving the HDT2 section can be used as it stands or fractionated according to the distillation temperature ranges, to supply a steam cracker, optionally after having undergone cracking in an FCC, a hydrocracker, or a catalytic reformer, preferably a hydrocracker.

This hydrocracking comprises for example putting the hydrotreated effluent in contact with a hydrotreatment catalyst, in particular a hydrocracking catalyst, in the presence of H₂, and to produce an effluent complying with the specifications of a steam cracker in terms of final boiling point (<370° C.), chlorine content (<5 ppm by mass) and olefins (<1% m).

This hydrocracking reaction can be implemented at a temperature of 250 to 480° C., a partial hydrogen pressure of 1.5 to 25 MPa abs. and an hourly volume velocity of 0.1 to 10 h⁻¹.

A hydrocracking catalyst that can be used comprises for example a support selected from halogenated aluminas, combinations of boron and aluminum oxides, amorphous silica-aluminas and zeolites and a hydro-dehydrogenating function comprising at least one metal in group VIB selected from chromium, molybdenum, and tungsten, alone or in a mixture, and/or at least one metal in group VIII selected from iron, cobalt, nickel, ruthenium, rhodium, palladium, and platinum.

1-13. (canceled)

14. Method for producing paraffins by hydrotreatment from a composition comprising a plastic liquefaction oil, said composition comprising at least 50% m/m paraffins and olefins in C5-C150, aromatics and heteroatoms selected from oxygen, nitrogen, sulfur, silicon, a metal, and/or a halogen, the method comprising:
(a) a step of separating part of the paraffins and olefins contained in said composition comprising at least one step (i) of crystallizing said composition by a reduction of the temperature of 10° C. to 60° from an initial temperature at which said composition is entirely liquid and obtaining a mixture comprising a solid product rich in paraffins and depleted of olefins, aromatics and heteroatoms, and an effluent depleted of paraffins and rich in olefins, aromatics and heteroatoms, followed by at least one step (ii) of separating said solid product and said effluent,
(b) a step of hydrotreatment of the solid product from step (a) and obtaining a hydrotreated effluent having a reduced olefin content, and optionally a reduced heteroatom and aromatic content,
(c) a step of steam cracking of the hydrotreated effluent and obtaining an effluent containing olefins.
and during the separation step (a), said composition is mixed with at least one solvent selected from a ketone and an alcohol prior to the at least one crystallization step (i), the at least one solvent being in the liquid state and miscible with the composition at the implementation temperatures of step (a).

15. Method according to claim 14, furthermore comprising a step (iii) of separating the at least one solvent from the effluent resulting from the separation step (ii) and the returning of the at least one solvent separated to step (i).

16. Method according to claim 14, characterized in that the volume ratio of said composition to the solvent is from 10/90 v/v to 90/10 v/v, or from 20/80 v/v to 80/20 v/v, preferably from 40/60 v/v to 60/40 v/v or from 45/55 v/v to 55/45 v/v.

17. Method according to claim 14, characterized in that:
the separation step (a) comprises:
(i-1) a first step of crystallization by reduction of the temperature of said composition of 10° C. to 60° C. from a first initial temperature at which said composition is entirely liquid and the obtaining of a first mixture comprising a first solid product rich in paraffins and depleted of olefins, aromatics and heteroatoms, and a first effluent depleted of paraffins and rich in olefins, aromatics and heteroatoms,
(ii-1) a first step of separating said first solid product and said first effluent,
(i-2) a second step of crystallization by reduction of the temperature of said first effluent of 10° C. to 60° C. from a second initial temperature at which said first effluent is entirely liquid and the obtaining of a second mixture comprising a second solid product rich in paraffins and depleted of olefins, aromatics and heteroatoms, and a second effluent depleted of paraffins and rich in olefins, aromatics and heteroatoms,
(ii-2) a second step of separating said second solid product and said second effluent, and
the first solid product and the second solid product are subjected to the hydrotreatment step (b).

18. Method according to claim 14, characterized in that the separation step (ii), (ii-1) or (ii-2) is implemented by at least one step selected from filtration, decantation or centrifugation.

19. Method according to claim 14, characterized in that the hydrotreatment of step (b) is implemented in a single step wherein the solid product or products resulting from step (a) are hydrogenated at a temperature of 200 to 450° C., preferably from 200 to 340° C. in the presence of hydrogen at an absolute pressure of 20 to 140 bar, preferably from 30 to 100 bar and in the presence of a hydrotreatment catalyst.

20. Method according to claim 14, characterized in that the hydrotreatment of step (b) is implemented in a first step (b-1) wherein the solid product or products resulting from step (a) are hydrogenated at a temperature of 80 to 250° C., preferably from 130 to 190° C. in the presence of hydrogen at an absolute pressure of 5 to 60 bar, preferably from 20 to 30 bar and in the presence of a hydrotreatment catalyst, and in a second step (b-2) wherein the effluent resulting from step (b-1) is hydrogenated at a temperature of 200 to 450° C., preferably from 200 to 340° C. in the presence of hydrogen at an absolute pressure of 20 to 140 bar, preferably from 30 to 100 bar and in the presence of a second hydrotreatment.

21. Method according to claim 14, characterized in that, prior to the steam-cracking step (c), the hydrotreated effluent resulting from step (b) is subjected to a cracking reaction.

22. Method for upgrading plastic waste comprising the following steps:
(A) a step of liquefying waste containing plastics materials and obtaining a hydrocarbon product comprising a gaseous phase, a liquid phase and a solid phase,
(B) a step of separating the liquid phase from said product, said liquid phase forming a plastic liquefaction oil,
(C) a step of treating at least part of the liquid phase by an olefin-production method according to claim 14.
